(19) United States
(12) Patent Application Publication
(10) Pub. No.: US 2008/0268302 A1
(43) Pub. Date: Oct. 30, 2008

(54) ENERGY PRODUCTION SYSTEMS AND METHODS

(76) Inventor: Joe McCall, Sandy Springs, GA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/115,155

(22) Filed: May 5, 2008

Related U.S. Application Data
(63) Continuation-in-part of application No. 12/015,638, filed on Jan. 17, 2008.
(60) Provisional application No. 60/916,148, filed on May 4, 2007.
(60) Provisional application No. 60/885,361, filed on Jan. 17, 2007.

(51) Int. Cl. H01M 8/04; C10J 3/00

(52) U.S. Cl. 429/17; 48/197 R

(57) ABSTRACT

A photobioreactor includes a cultivation zone configured to contain a liquid culture medium and facilitate growth of a microalgae biomass, a plurality of parallel edge-lit light transmitting devices mounted within the cultivation zone, and a collection zone oriented in relation to the cultivation zone such that at least a portion of the liquid culture medium and microalgae from the cultivation zone may be periodically harvested. Methods for illuminating algae, for dissolving materials into an algae medium, for extracting oil from algae, and for producing biodiesel from algal oil are also provided.

### CROSS-REFERENCES TO RELATED APPLICATIONS

This application is a nonprovisional of, and claims the benefit of priority from, U.S. Provisional Patent Application No. 60/916,148 filed May 4, 2007. This application is also a continuation-in-part of U.S. patent application Ser. No. 12/015,638 filed Jan. 17, 2008, which claims the benefit of priority from U.S. Provisional Patent Application No. 60/885,361 filed Jan. 17, 2007. The entire content of each of these disclosures is incorporated herein by reference for all purposes.

### BACKGROUND OF THE INVENTION

Embodiments of the present invention involve techniques for generating energy, and in particular for producing electricity and biodiesel from algae.

There is considerable interest in the development of renewable energy sources to replace petroleum-based fuels. It has been discovered that certain algae have a large oil or lipid content, and thus provide a source for the production of biodiesel. In some cases, algae may contain up to 80% oil by weight. However, there is a lack of efficient and cost-effective algal biomass production systems. Open pond technology is often expensive and susceptible to contamination. Current closed photobioreactors using fiber optic light transmission can be prohibitively expensive.

Therefore, a need exists for improved devices and methods for generating biodiesel and other forms of energy from algae. Preferably, such techniques would provide sufficient illumination to algae cultures to support growth. Further, these approaches should provide the required nutrients and gases to support algal growth. These techniques should also provide for the removal of oil from algae cultures. At least some of these objectives will be met by embodiments of the present invention.

### BRIEF SUMMARY OF THE INVENTION

Embodiments of the present invention provide an improved approach for replacing fossil fuel feedstocks. Biodiesel and other alternative fuels can be produced from algal oil. Relatedly, electricity can be produced from algal pulp. Advantageously, embodiments of the present invention provide improved algae culture systems and methods. An exemplary photobioreactor includes a cultivation zone, a collection zone, and a heat sink. The photobioreactor can be in operative association with an agitator and an aggregator. Algae cultures can be grown, harvested, and processed to extract algal oil and pulp therefrom. Biodiesel can be produced from the algal oil, and electricity can be produced from the algal pulp. This can be done sustainably, affordably, and on a large scale. Closed systems can provide increased efficiency and cost effectiveness, and reduce the opportunity for contamination. In some cases, oxygen harvested from a photobioreactor can be used to support electricity production in a fuel cell. In some cases, water and carbon dioxide harvested from a fuel cell can be used in a photobioreactor to support algae growth in a closed loop fashion.

Techniques disclosed herein provide systems and methods for producing renewable, dispatchable electricity in a closed loop fashion, with little or no emissions. The electricity can be produced on demand at any time. Moreover, techniques are disclosed for producing various forms of fuel such as methanol, ethanol, and biodiesel, which may be used for transportation. These forms of fuel can be produced selectably. Embodiments of the present invention also encompass methods that involve no net production of green house gases. It is possible to use renewable sources for exogenous power. For example, photovoltaic energy techniques can be used for electricity and solar thermal techniques can be used for heating and cooling. Hence, embodiments include systems and methods that involve renewable energy, such that the use of fossil fuels is greatly diminished.

In a first aspect, embodiments of the present invention provide a method for illuminating algae. The method can include concentrating a stream of light, transmitting the concentrated stream of light to a first portion of a diffusing member, diffusing the concentrated stream of light with the diffusing member, radiating the diffused stream of light from a second portion of the diffusing member, and illuminating the algae with the diffused stream of light. In some cases, the diffusing member comprises a diffusing plate having diffuser particles embedded therein. Relatedly, the diffusing member may include an edge-lit acrylic polymer sheet. The stream of light can be concentrated with a tandem compound parabolic concentrator, a linear Fresnel lens, or the like. In another aspect, embodiments of the present invention provide a method of extracting an algal oil from an algae. The method can include placing the algae in a space between a rotor and a housing, generating relative rotational movement between the rotor and the housing so as to agitate the algae, breaking a cell wall of the algae to allow algal oil to release from the algae into a suspension, flocculating the suspension with a standing sonic wave to isolate the algal oil and pulp, and removing the algal oil and pulp from the suspension. It is understood that in some embodiments, algae which has not been disrupted or agitated can be flocculated with a standing wave so as to isolate the algae from other components in the algae culture. Hence, as discussed elsewhere herein, whole cell or nondisrupted algae can be placed in a gasifier for gasification. In some aspects, the method may include producing a biodiesel fuel from the algal oil. In another aspect, embodiments of the present invention provide a method of introducing carbon dioxide into an algae suspension. The method can include, for example, transferring the algae suspension from a photobioreactor to an agitation device, and introducing carbon dioxide into the algae suspension with the agitation device. Any of a variety of nutrients or gasses can be introduced into an algae suspension using the agitation device.

In another aspect, embodiments of the present invention provide a photobioreactor for growing and processing an algae culture. The photobioreactor can include a cultivation zone configured to contain a liquid culture medium and facilitate growth of a microalgae biomass, a plurality of parallel edge-lit, light emitting devices mounted within the cultivation zone and extending in a first direction. Each light-emitting device can have a light concentration surface to direct light into the light emitting device. The photobioreactor may also include a collection zone oriented in relation to the cultivation zone such that at least a portion of the liquid culture medium and microalgae from the cultivation zone may be periodically harvested. In some cases, the cultivation zone has a rectangular configuration with a first and a second pair of opposite sidewalls. The light-emitting devices may be positioned so as to extend between the first pair of sidewalls at a predetermined spacing. In some cases, each light emitting device further include or be in operative association with at least one cleaning element that runs along an outer surface of the light emitting device, for cleaning the surface of the light emitting device. The cleaning element may include a brushing apparatus, a scraping apparatus, or the like. The light concentrating surface may be a linear Fresnel lens, a compound parabolic concentrator, or the like. The collection zone can have a rectangular configuration with a first and second pair of opposite sidewalls, can be positioned below the cultivation zone, and can have a total volume sufficient to harvest at least half of the volume of the cultivation zone at periodic intervals. In some aspects, the photobioreactor may have a zone for recovering heat from the cultivation zone, and for cooling the same.

In yet another aspect, embodiments of the present invention provide a culture unit for cultivating microalgae. The culture unit can include, for example, a photobioreactor, a hydrodynamic separation zone in fluid communication with the photobioreactor, and a flocculation tank configured so as to receive material from the separation zone for separation of a biofuel from the microalgae biomass. In some aspects, the hydrodynamic separation zone includes a cavitation mixer capable of separating at least a portion of the microalgae biomass and liquid culture medium into a solid phase containing the solid components of the microalgae and at least one liquid phase. A still further aspect of the present invention provides a method for producing a biofuel. The method may include growing an algae in a cultivation zone of a photobioreactor, transferring the algae from the cultivation zone to a collection zone of the photobioreactor, transferring the algae to an agitator, disrupting the algae to release algal oil therefrom, transferring the disrupted algae and algal oil from the agitator to an aggregator, flocculating the disrupted algae and algal oil with the aggregator, allowing the algal oil to separate from the disrupted algae, and collecting the algal oil and converting the algal oil to the biodiesel. In some cases, the process of growing the algae can include concentrating a stream of light, transmitting the concentrated stream of light to a first portion of a diffusing member, diffusing the concentrated stream of light with the diffusing member, radiating the diffused stream of light from a second portion of the diffusing member, and illuminating the algae with the diffused stream of light. In some cases, the process of disrupting the algae can include placing the algae in a space between a rotor and a housing, generating relative rotational movement between the rotor and the housing so as to agitate the algae, and breaking a cell wall of the algae to allow algal oil to release from the algae. The method may also include introducing carbon dioxide into an algae medium with the agitator.

In one aspect, embodiments of the present invention encompass methods for illuminating an algae. Exemplary embodiments include concentrating a stream of light, transmitting the stream of light to an illuminator having a first surface and a second surface opposite the first surface, transmitting the stream of light within the illuminator between the first and second surface to a reflector disposed between the first surface and the second surface, radiating the stream of light through either the first surface or the second surface of the illuminator, and illuminating the algae with the stream of light. In some cases, the stream of light can be concentrated with a light concentrator having an aperture, and the stream of light can be transmitted through the aperture of the light concentrator to the illuminator. Optionally, the stream of light can be concentrated with a parabolic concentrator, such as a compound parabolic concentrator.

In another aspect, embodiments of the present invention include methods of extracting an algal oil from an algae cultivated in a photobioreactor. Exemplary methods include cultivating the algae in a photobioreactor, placing the algae in a space between a rotor and a housing, generating relative rotational movement between the rotor and the housing so as to agitate the algae, breaking a cell wall of the algae to allow algal oil to release from the algae into a suspension, flocculating the suspension with a standing wave to isolate the algal oil from a pulp comprising the cell wall, and removing the algal oil and the pulp from the suspension. In some cases, the rotor is disposed at least partially within the housing in a concentric arrangement, and the step of generating relative rotational movement between the rotor and the housing comprises creating cavitation in the space between the rotor and the housing to agitate the algae.

In a further aspect, embodiments of the present invention include methods of extracting an algal oil from an algae cultivated in a photobioreactor. Exemplary methods include cultivating or growing an algae in a photobioreactor, placing the algae in an agitator, breaking a cell wall of the algae with the agitator to allow algal oil to release from the algae into a suspension, transferring the suspension from the agitator to an aggregation tank, creating a standing sonic wave in the suspension contained within the aggregation tank with a standing sonic wave generator, aggregating a pulp comprising the cell wall at a pressure node formed by the standing sonic wave, and allowing the pulp to settle toward the bottom of the aggregation tank, separate from the algal oil. In some embodiments, methods include removing the algal oil through a first passage disposed toward a top portion of the aggregation tank. Methods may also include removing the pulp through a second passage disposed toward a bottom portion of the aggregation tank.

In yet another aspect, embodiments of the present invention include methods of extracting an algal oil from an algae. Exemplary methods include placing the algae in a space between a rotor and a housing, where the rotor is disposed at least partially within the housing in a concentric arrangement, and generating relative rotational movement between the rotor and the housing so as to create cavitation in the space between the rotor and the housing and agitate the algae. Methods may also include breaking a cell wall of the algae to allow algal oil to release from the algae into a suspension, and transferring the suspension to an aggregation tank, where the suspension includes the algal oil and the cell wall. Further, methods may include creating a standing sonic wave in the suspension with a standing sonic wave generator, aggregating a pulp, which may include the cell wall, at a pressure node, and allowing the pulp to settle toward the bottom of the aggregation tank, separate from the algal oil. Methods may include removing the algal oil through a first passage disposed toward a top portion of the aggregation tank, removing the pulp through a second passage disposed toward a bottom portion of the aggregation tank, transferring a volume comprising at least a portion of the suspension remaining in the aggregation tank to the space between the rotor and the housing, and infusing the volume with carbon dioxide and nutrients via cavitation.

In some aspects, embodiments of the present invention encompass photobioreactors for growing or cultivating a microalgae biomass. An exemplary photobioreactor can include a cultivation zone configured to contain a liquid culture medium and facilitate growth of the microalgae biomass, and a light concentrator mounted above the cultivation zone. The light concentrator can have a light concentration surface that concentrates a stream of light and directs the stream of light toward an illuminator. The illuminator may include a first surface and a second surface opposite the first surface, and a reflector disposed between the first surface and the second surface that reflects the stream of light through the first surface or the second surface of the illuminator so as to illuminate the microalgae biomass. In some cases, a light concentrator may include an aperture, and the light concentration surface may have a parabolic shape. In some cases, a photobioreactor may include one or more cleaning elements that runs along the first surface or the second surface of the illuminator. Optionally, a cleaning element may include a brushing apparatus or a scraping apparatus. In some cases, a light concentrator may include a compound parabolic concentrator. According to some embodiments, a photobioreactor may include a collection zone having a rectangular configuration with a first and second pair of opposite sidewalls. A collection zone may have a total volume sufficient to harvest at least half of the volume of the cultivation zone at periodic intervals. Optionally, a photobioreactor may include a zone for recovering heat from the cultivation zone, and cooling the cultivation zone.

In another aspect, embodiments of the present invention include a culture unit for cultivating microalgae. An exemplary culture unit may include a cultivation zone configured to contain a liquid culture medium and facilitate growth of the microalgae, and a light concentrator mounted above the cultivation zone, where the light concentrator has a light concentration surface that concentrates a stream of light and directs the stream of light toward an illuminator. A culture unit may also include a collection zone in fluid communication with the cultivation zone, a hydrodynamic separation zone in fluid communication with the cultivation zone, and a flocculation tank in fluid communication with the hydrodynamic separation zone. The hydrodynamic separation zone may include a cavitation mixer having a rotor and a housing, where the rotor is disposed at least partially within the housing in a concentric arrangement. Optionally, a cavitation mixer can be configured to separate at least a portion of the microalgae and liquid culture medium into a solid phase containing a solid component of the microalgae and at least one liquid phase. In some cases, a culture unit may include a standing sonic wave generator configured to create a standing sonic wave within the flocculation tank. According to some embodiments, an illuminator may include a first surface and a second surface opposite the first surface. The illuminator may also include a reflector disposed between the first surface and the second surface that reflects the stream of light through the first surface or the second surface of the illuminator so as to illuminate the microalgae. A culture unit may also include an oxygen container in fluid communication with a cultivation zone. For example, a cultivation zone may be coupled with an oxygen container via a port or conduit. Oxygen produced by algae contained in the cultivation zone can be transferred from the cultivation zone, optionally via the port or conduit, to the oxygen container.

In another aspect, embodiments of the present invention encompass systems and methods for producing electricity and a biodiesel fuel from an algae culture. Such systems and methods can involve techniques such as obtaining an algae pulp from the algae culture, obtaining an algae lipid from the algae culture, processing the algae pulp to produce the electricity, and processing the algae lipid to produce the biodiesel fuel. In some cases, the step of processing the algae pulp can include producing methanol, and the step of processing the algae lipid can include combining the algae lipid with the methanol to provide the biodiesel fuel.

In some aspects, embodiments of the present invention encompass systems and methods for producing electricity from an algae culture. These techniques can involve obtaining an algae pulp from the algae culture, obtaining oxygen from the algae culture, processing the algae pulp to produce methanol, and processing the methanol with the oxygen in a fuel cell to produce the electricity.

In other aspects, embodiments of the present invention include methods and systems for producing a biodiesel fuel from an algae culture. Such techniques can involve obtaining an algae pulp from the algae culture, obtaining an algae lipid from the algae culture, processing the algae pulp to produce methanol, and processing the methanol with the algae lipid to produce the biodiesel fuel.

In a further aspect, embodiments of the present invention encompass methods and systems for producing ethanol from an algae culture. Exemplary techniques involve obtaining an algae pulp from the algae culture, processing the algae pulp in a gasification assembly to produce a Syngas, and processing the Syngas to produce the ethanol.

In a still further aspect, embodiments of the present invention encompass methods and systems for producing methanol from an algae culture. These techniques involve obtaining an algae pulp from the algae culture, processing the algae pulp to produce a Syngas, and processing the Syngas to produce the methanol. It is understood that production of Syngas from algae or algae pulp may provide endogenous methane. In a catalytic gasification, a portion of this endogenous methane may be cracked, such that the resulting Syngas includes relatively low amounts or percentages (e.g. 2%) of methane. In some cases, the step of processing the Syngas to produce the methanol includes producing the Syngas in a gasification assembly, cracking exogenous methane in the gasification assembly to provide hydrogen, and processing the hydrogen and the Syngas in a catalytic methanol synthesis assembly to produce the methanol. Hence, the gasification assembly can operate to crack endogenous methane from the Syngas, as well as exogenous methane injected from an external source. In some cases, the Syngas includes carbon dioxide, and processing the Syngas to produce the methanol includes producing the Syngas in a gasification assembly, cracking methane in the gasification assembly to provide hydrogen, processing the hydrogen and the Syngas in a catalytic methanol synthesis assembly to produce the methanol and reduce substantially all of the carbon dioxide.

In some aspects, embodiments encompass a systems and methods for reducing carbon dioxide in a Syngas. These techniques can include cracking methane to provide hydrogen, and processing the hydrogen and the Syngas in a catalytic methanol synthesis assembly to reduce substantially all of the carbon dioxide in the Syngas. In some cases, producing the Syngas includes gasifying an algae pulp in the gasification assembly.

In another aspect, embodiments of the present invention encompass systems and methods for removing dissolved oxygen from an algae culture media. These approaches can involve exposing the algae culture media to a negative pressure condition, and allowing at least a portion of the dissolved oxygen in the algae culture media to leave the algae culture media.

In a further aspect, embodiments of the present invention include systems and methods for producing electricity and a biodiesel fuel from an algae culture. These techniques can include concentrating a stream of light, transmitting the concentrated stream of light to a first portion of a diffusing member, diffusing the concentrated stream of light with the diffusing member, radiating the diffused stream of light from a second portion of the diffusing member, illuminating the algae in a photobioreactor assembly with the diffused stream of light, allowing the algae to grow, and removing the algae from the photobioreactor assembly. The techniques can also include transferring the algae to a harvesting and infusing assembly, disrupting the algae to produce an algae pulp and an algae oil, flocculating the algae pulp and algal oil, and allowing the algae pulp and the algae oil to separate. Further, the techniques can include transferring the algae pulp to a gasification assembly, processing the algae pulp in the gasification assembly to produce a Syngas; transferring methane to the gasification assembly, and cracking the methane in the gasification assembly to produce hydrogen. These approaches can also include transferring the Syngas and the hydrogen to a catalytic methanol synthesis assembly, processing the Syngas and the hydrogen in the catalytic methanol synthesis assembly to produce methanol, transferring a first portion of the methanol to a fuel cell assembly, processing the methanol in the fuel cell assembly to produce electricity, transferring the algae oil and a second portion of the methanol to a refining assembly, and processing the algae oil and the second portion of the methanol to produce the biodiesel fuel. In some cases, the algae is processed so as to limit a respiration phase of the algae.

In one aspect, embodiments of the present invention encompass methods of producing methanol from algae or algae pulp. Methods may include processing the algae or algae pulp in a gasification assembly to produce a Syngas comprising an amount of carbon dioxide and a first amount of methane, introducing a second amount of methane into the gasification assembly to provide a sum amount of methane in the gasification assembly, cracking at least a portion of the sum amount of methane in the gasification assembly to provide an amount of hydrogen, and reacting at least a portion of the amount of carbon dioxide with at least a portion of the amount of hydrogen in a catalytic methanol synthesis assembly to produce the methanol. Some methods involve reducing substantially all of the amount of carbon dioxide to methanol. Some methods include transferring an amount of unreacted gas from the catalytic methanol synthesis assembly to the gasification assembly. In some instances, the unreacted gas includes unreacted carbon dioxide or unreacted hydrogen. Some methods involve introducing a third amount of methane into the gasification assembly based on the amount of unreacted gas that is transferred from the catalytic methanol synthesis assembly to the gasification assembly.

In one aspect, embodiments of the present invention include methods of producing electricity from an algae grown in a photobioreactor. For example, methods may include introducing oxygen produced by the algae into a hydrogen fuel cell assembly. Optionally, methods may include introducing algae, or algae pulp obtained from the algae, into a gasification assembly. Methods may further include processing the algae or algae pulp in the gasification assembly to produce a Syngas comprising carbon dioxide and methane, introducing the carbon dioxide into a catalytic methanol synthesis assembly, introducing hydrogen produced from the methane into the catalytic methanol synthesis assembly, processing the carbon dioxide and the hydrogen in the catalytic methanol synthesis assembly to produce methanol, introducing the methanol into the hydrogen fuel cell assembly, and processing the oxygen and the methanol in the fuel cell assembly to produce electricity. In some cases, the methane is processed in the gasification assembly to produce the hydrogen. Some methods may further include introducing water produced in the hydrogen fuel cell assembly into a harvesting and infusing assembly. Methods may also include introducing an algae lipid from the algae into a refining assembly and producing biodiesel from the algae lipid. Optionally, methods may include producing ethanol from at least a portion of the Syngas. Cultivation of algae may be supported with carbon dioxide obtained from a hydrogen fuel cell assembly.

In another aspect, embodiments encompass methods of cultivating an algae. Methods may include, for example, introducing oxygen produced by the algae into a hydrogen fuel cell assembly, introducing methanol produced by the gasification of the algae, or optionally an algae pulp of the algae, into the hydrogen fuel assembly, processing the oxygen and the methanol in the hydrogen fuel cell assembly to produce carbon dioxide and water, and cultivating the algae with the carbon dioxide and the water. Methods may further include processing the oxygen and the methanol in the fuel cell assembly to produce electricity. Methods may also involve producing biodiesel from an algae lipid obtained from the algae. Further, methods may include obtaining a Syngas from the gasification of the algae or algae pulp and processing the Syngas to produce ethanol.

For a fuller understanding of the nature and advantages of the present invention, reference should be had to the ensuing detailed description taken in conjunction with the accompanying drawings.

### BRIEF DESCRIPTION OF THE DRAWINGS

FIG. 1 shows a culture system according to embodiments of the present invention.

FIGS. 1A to 1C illustrate a cleaning mechanisms according to embodiments of the present invention.

FIG. 1D depicts a culture system according to embodiments of the present invention.

FIG. 1E illustrates aspects of an algae processing method according to embodiments of the present invention.

FIG. 1F illustrates aspects of an algae processing method according to embodiments of the present invention.

FIG. 2 shows a photobioreactor according to embodiments of the present invention.

FIG. 2A shows a culture system according to embodiments of the present invention.

FIG. 2B shows a culture system according to embodiments of the present invention.

FIG. 3 shows a light transmission assembly according to embodiments of the present invention.

FIG. 3A depicts a light transmission assembly according to embodiments of the present invention.

FIG. 3B illustrates a compound parabolic concentrator according to embodiments of the present invention.

FIG. 4 shows an agitator according to embodiments of the present invention.

FIGS. 5 and 5A-5D show an aggregator according to embodiments of the present invention.

FIG. 6 illustrates aspects of an energy production system according to embodiments of the present invention.

### DETAILED DESCRIPTION OF THE INVENTION

Culture systems and methods are provided for improved algal growth and algal oil extraction from algal cultures. These systems and methods are well suited for the large scale production of biodiesel and other renewable fuels, and for the production of electricity.

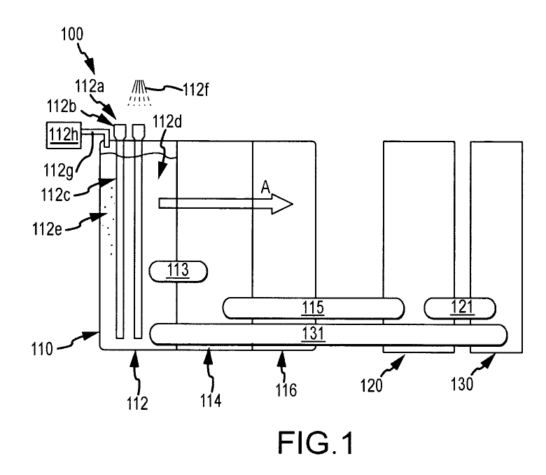

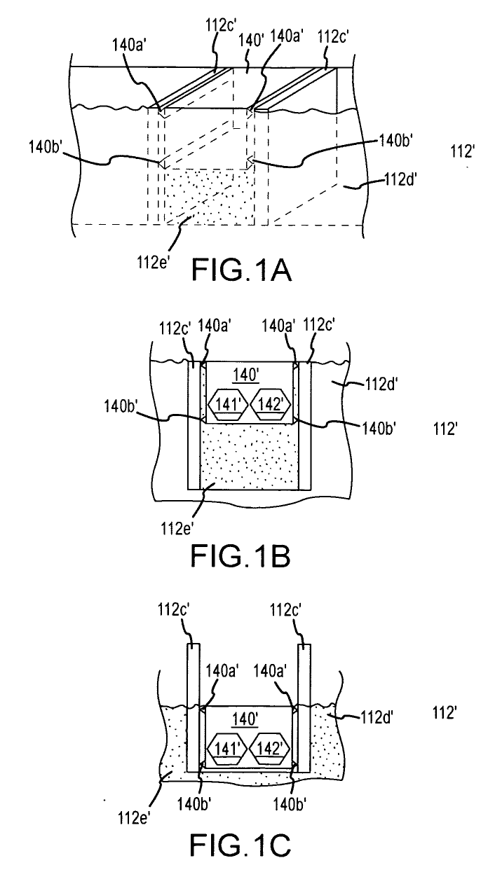

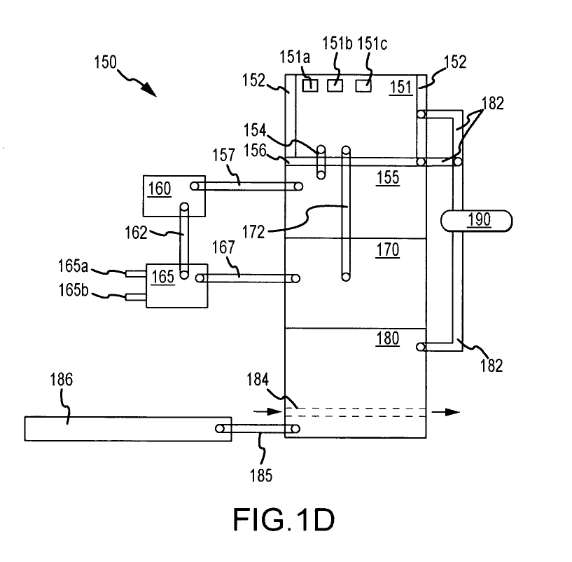

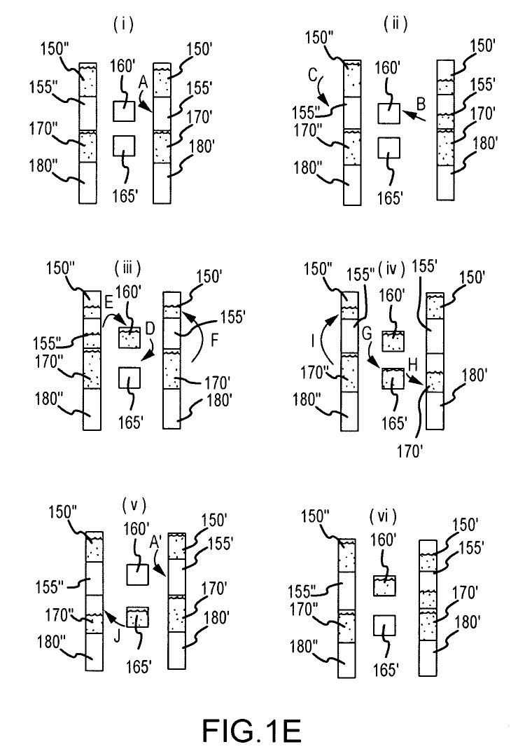

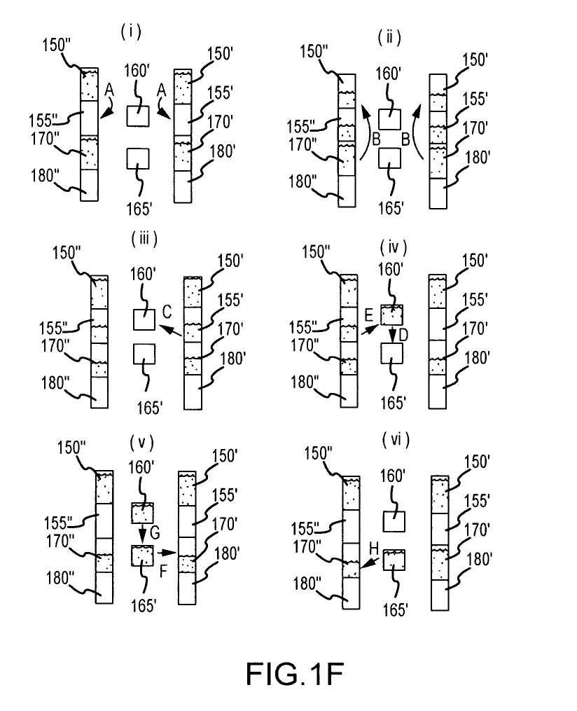

Turning now to the drawings, FIG. 1 schematically illustrates a culture system 100 according to embodiments of the present invention. Culture system 100 may include a photobioreactor 110, an agitator 120, and an aggregator or settling tank 130. As shown here, photobioreactor 110 includes a cultivation zone 112, a collection zone 114, and a heat sink 116. Cultivation zone 112 can be in fluid communication with collection zone 114 via a passage or conduit 113. Collection zone 114 can be in fluid communication with agitator 120 via a passage or conduit 115. Agitator 120 can be in fluid communication with aggregator or settling tank 130 via a passage or conduit 121. Similarly, aggregator 130 can be in fluid communication with cultivation zone 112 via a passage or conduit 131. Heat sink 116 can be configured to receive or conduct heat from cultivation zone 112, as indicated by arrow A. In use, an algae culture can be grown or maintained in cultivation zone 112. Typically, cultivation zone 112 provides energy and nutrient requirements sufficient to support or facilitate algae growth, which may include macroalgae or microalgae organisms, such as Botryococcus braunii and the like.

In a standard photobioreaction such as photosynthesis, light, water, and carbon dioxide are converted to carbohydrate, lipid, protein, and oxygen. These reactions can be carried out by chloroplasts and chlorophyll in an algae organism. Certain aspects of photobioreactions are discussed in O. Pulz, “Photobioreactors: production systems for phototrophic microorganisms,” Appl. Microbiol. Biotechnol. 57(3):287-293 (2001), and in Barbosa et al., “Microalgal photobioreactors: Scale-up and optimization,” Chapter 7 pp. 115-148 (2003), the entire contents of each of which are incorporated herein by reference for all purposes. In some embodiments, the dimension of cultivation zone 112, as well as other components of culture system 100, can be optimized for efficient and cost effective manufacturing, shipping, and storage. In some embodiments, one or more components of system 100 may be configured for placement in a cargo container or on a production line.

In some embodiments, cultivation zone 112 includes a light transmission assembly 112a having a light collecting and concentrating means 112b and a light dispersing or distributing means or illuminator 112c. For example, light transmission assembly 112a may include a plurality of parallel edge-lit light dispersing or distributing devices that are mounted within the cultivation zone. Hence, photobioreactor embodiments of the present invention may include a single cultivation zone containing a plurality of light transmission assemblies. The light collecting and concentrating means 112b can have a light concentration surface to direct light into or toward the light diffusing or distributing device or illuminator. In some embodiments, a light concentration surface or collecting and concentrating means 112b can include a linear Fresnel lens, a compound parabolic concentrator, a tandem compound parabolic concentrator, and the like. Sunlight or other ambient light can be collected, concentrated, and transmitted into the dispersing devices or illuminators. Light can then be dispersed, radiated, directed, or distributed into a cultivation medium 112d so as to supply or supplement the light requirements of an algae culture 112e contained within the medium. In use, light transmission assembly can concentrate a stream of light 112f, transmit the concentrated stream of light to a first portion of diffusing member or illuminator 112c, diffuse the concentrated stream of light with the diffusing member, and radiate the diffused stream of light from the diffusing member toward the algae culture so as to illuminate the algae with the diffused stream of light. A photobioreactor or other components of the culture system 100 may also include one or more temperature control means. In some embodiments, cultivation zone 112 may include or be coupled with a port or conduit 112g for transporting oxygen out of the cultivation zone and into an oxygen container 112h.

In some embodiments, cultivation zone 112 has a rectangular configuration with a first and a second pair of opposite sidewalls. For example, a first pair of opposite sidewalls may include a right sidewall and a left sidewall, and a second pair of opposite sidewalls may include a front sidewall and a rear sidewall. Typically, the individual sidewalls of the pair are parallel with each other. Light diffusing devices or illuminators can be positioned so as to extend between the first pair of sidewalls at a predetermined spacing. A light diffusing device or illuminator can include or be in operative association with cleaning element or mechanism for cleaning an outer surface of the light diffusing device. In some cases, a cleaning element may include a brushing apparatus or a scraping apparatus. Additional features of cleaning mechanisms are further discussed below in reference to FIGS. 1A to 1C.

After algae culture 112e has grown as desired, the culture can be transferred via conduit 113 to collection zone 114. An optical testing device can be used to determine whether the density of algae in the cultivation zone has reached a desired level. In some cases, at least a portion of the liquid culture medium and the algae from the cultivation is harvested into the collection zone or harvest tank 114. The collection zone can be positioned below or beneath the cultivation zone. The collection zone can have a total volume sufficient to harvest at least half of the volume of the cultivation zone at periodic intervals. Thus, the harvesting may be performed on a periodic basis. In some cases, unwanted heat may be generated in the photobioreactor, due to the algal growth or heat from the light. For example, if the culture media becomes too hot, the algae may not produce desired levels of oil. If the media becomes too cold, the growth rate of the algae may be slower than desired. Accordingly, system 100 may include a means for regulating temperature in the photobioreactor. Heat sink 116 can act to recover heat from thus cool the cultivation zone. Algae culture and media can then be transferred from collection zone 114 to agitator 120.

Agitator 120, or a portion thereof, may be in fluid communication with collection zone 114 of photobioreactor 110. In some embodiments, agitator 120 includes a hydrodynamic separation zone having a cavitation mixer or a hydrodynamic wheel capable of separating at least a portion of the algae biomass and liquid culture medium into a solid phase containing the solid components of the algae and at least one liquid phase. In use, algae can be placed into a space between a rotor and a housing of agitator 120. By generating relative rotational movement between the rotor and the housing, the agitator 120 can agitate the algae. This agitation can act to break an algal cell wall, and thus algal oil can be released from the algae into a suspension. Contents of agitator 120 can then be transmitted to aggregator 130 via conduit 121. In some embodiments, agitator 120 acts to heat the agitated material. Agitator 120 may include a fluid processing device as described in U.S. Pat. Nos. 5,188,090, 5,385,298, and 5,957,122, all to Griggs, which are incorporated herein by reference. In some cases, agitator 120 may act to mix or integrate carbon dioxide or other gases or nutrients into the media via a cavitation process. In this way, media can be prepared for introduction to the cultivation zone for growth or maintenance of the algae culture. Exemplary mixing devices and techniques are described in U.S. Patent Publication No. 2006/0126428 published Jun. 15, 2006, U.S. Patent Publication No. 2005/0150618 published Jul. 14, 2005, U.S. Patent Publication No. 2005/0067122 published Mar. 31, 2005, U.S. Patent Publication No. 2004/0103783 published Jun. 3, 2004, and U.S. Pat. No. 6,627,784 issued Sep. 30, 2003, all to Hudson et al., the contents of each of which are incorporated herein by reference. Aggregator 130 may include a flocculation tank configured so as to receive material from the separation zone for separation of a biofuel from a microalgae biomass. In some embodiments, one or more culture system components can be preassembled prior to shipping or transporting to an installation site.

As shown in FIGS. 1A to 1C, a cleaning mechanism 140′ may be disposed in a cultivation zone 112′ of a photobioreactor. Cleaning mechanism 140′ may be constructed of a wire frame, and can include a pair of upper wiping elements 140a′ and a pair of lower wiping elements 140b′. As shown in FIG. 1A, cleaning mechanism 140′ is floating in a cultivation medium 112d′, and is situated between two illuminators 112c′. During the algae growing process, the outer surface of the illuminators may collect various sorts of debris, or portions of the algae culture 112e′ may adhere to the illuminator. When material is deposited in this way on the illuminators, the amount of light that passes through the illuminator and into the medium can decrease and thus algae growth can be inhibited. In some embodiments, cleaning mechanism includes or is coupled with a weighting assembly 141′, a buoyancy assembly 142′, or both, as depicted in FIG. 1B. Weighting assembly 141′ and buoyancy assembly 142′ can operate to modulate or control the sinking and floating characteristics or operation of cleaning mechanism 140′. In operation, upper wiping elements 140a′ act to scrape or scrub debris or algae from the upper one half of illuminators 112c′, while lower wiping elements 140b′ act to scrape or scrub debris or algae from the lower one half of illuminators 112c′. This scraping or scrubbing action occurs as cleaning mechanism 140′ travels between an upper position as shown in FIG. 1B, for example when cultivation zone 112′ is completely filled with growth media 112d′, and a lower position as shown in FIG. 1C, for example when cultivation zone 112′ is half filled with growth media 112d′. In some embodiments, the wiping elements are biased so as to press against the sides of the illuminators. For example, the wiping elements may include a flexible rubber blade or edge that runs along the surface of the illuminator. Similarly, the wiping element may include a spring loaded mechanism that urges a scraping or scrubbing feature of the wiping element against the surface of the illuminator. Exemplary wiping elements may include brushes, blades, scrapers, squeegees, wipers, and the like.

FIG. 1D shows a culture system 150 according to embodiments of the present invention. Culture system 150 includes a photobioreactor having a cultivation zone 151, a collection zone 155, a supplemental collection zone 170, and a heat sink 180. Culture system 150 also includes an agitator 160 and an aggregator 165. Cultivation zone 151, or other components of culture system 150, may include any of a variety of sensors, such as a temperature sensor 151a, a light sensor 151b, or a nutrient or gas sensor 151c. These sensors may be configured to provide culture parameter data to processors or other control mechanisms of the culture system, whereby the operating conditions of the culture system may be controlled or adjusted as desired. As shown here, cultivation zone 151 is in fluid communication with collection zone 155 via conduit 154, collection zone 155 is in fluid communication with agitator 160 via conduit 157, agitator 160 is in fluid communication with aggregator 165 via conduit 162, aggregator 165 is in fluid communication with supplemental collection zone 170 via conduit 167, and supplemental collection zone 170 is in fluid communication with cultivation zone 151 via conduit 172. In some embodiments, agitator 160, aggregator 165, or both, are adjacent to or abut other elements of the culture system, such as the collection zone, the heat sink, or the like. Heat sink 180 is in fluid communication with side panel 152 and bottom panel 156 of cultivation zone 151 via conduit 182. Culture system 150 may include a pump 190 in operative association with conduit 182. In some embodiments, pump 190 may operate to direct fluid from heat sink 180 to one or more panels or heat transfer components of cultivation zone 151. Similarly, pump 190 may operate to direct fluid from one or more panels or heat transfer components of cultivation zone 151 to heat sink 180. Culture system 150 may also include a temperature regulation device 186 in fluid communication with heat sink 180. Temperature regulation device 186 may include a heat dissipation mechanism, a heat collection mechanism, or a combination thereof. In some embodiments, heat sink 180 may include one or more fluid flow tubes or passages 184, which allow ambient or other air or fluid to flow through heat sink 180 and transmit heat to or remove heat from fluid contained in heat sink 180. By providing heat regulation elements such as heat sink 180, temperature regulation device 186, and fluid flow tubes 184, embodiments of the present invention allow for precise and efficient control of heating and cooling of the cultivation zone. The heat regulation features described herein are useful when culture systems are operated in environments that are subject to significant fluctuations in ambient temperature. For example, high desert plains often experience daily and seasonal temperature fluctuations. These heat regulation features can be used to maintain optimal or desired temperatures in the cultivation zone, which may depend on the species of algae or organism cultured, even during extreme temperature swings. Thermal energy from the sun is at least in part due to light in the infrared range, and in some cases a heat regulation feature according to embodiments of the present invention includes a covering that can be placed over the photobioreactor or other component of the culture system. The covering can include selected amounts of infrared absorbing or reflecting material, so as to prevent infrared radiation from reaching the photobioreactor, or otherwise reduce the amount of infrared radiation passing through the covering. This feature may be useful when operating a culture system in a seasonal environment, where it may be desirable to allow the heat-producing infrared radiation to reach the photobioreactor during the cold season, but not to allow the infrared radiation to reach the photobioreactor during the warm season. It is appreciated that components of culture system 150 can be arranged in any horizontal or vertically stacked configuration.

In an exemplary method, algae culture and media are transferred from cultivation zone 151 to collection zone 155, and then are transferred to agitator 160. An agitation procedure shreds the algae and releases oil therefrom, and optionally infuses media with carbon dioxide or other gases or nutrients. Oil, algae pulp, and the like can be transferred from agitator 160 to aggregator 165. The aggregator, which can be or include a flocculation device, operates to separate oil, algae pulp, or both, from the media. Oil can be removed from the aggregator via a first output 165a, and algae pulp can be removed from the aggregator via a second output 165b. Media, optionally infused, can be transferred from aggregator 165 to supplemental collection zone 170, and can remain or be held there until it is transferred to cultivation zone 151.

FIG. 1E provides a schematic representation of an exemplary algae culture processing method according to embodiments of the present invention. With reference to stage (i), a first photobioreactor includes a first cultivation zone 150′, a first collection zone 155′, a first supplemental collection zone 170′, and a first heat sink 180′. In some embodiments, a culture system or culture plant may include one or more photobioreactors. Thus, the culture system depicted in stage (i) includes a second photobioreactor that includes a second cultivation zone 150″, a second collection zone 155″, a second supplemental collection zone 170″, and a second heat sink 180″. The culture system also includes an agitator 160′ and a settling tank 165′. Stage (i) indicates that cultivations zones 150′ and 150″ are each full of algae culture and media, and supplemental collection zones 170′ and 170″ are each full of infused culture media. In a first processing step, as indicated by arrow A, one half of the algae culture and media contained in first cultivation zone 150′ is transferred to first collection zone 155′. Stage (ii) indicates that first cultivation zone 150′ and first collection zone are each one half full of algae culture and media. In a second processing step, as indicated by arrows B and C respectively, the algae culture and media contained in first collection zone 155′ is transferred to agitator 160′, and one half of the algae culture and media contained in second cultivation zone 150″ is transferred to second collection zone 155″. Stage (iii) indicates that agitator 160′ contains the algae culture and media that was transferred from first collection zone 155′, and second collection zone 155″ contains the algae culture and media that was transferred from cultivation zone 150″. In a third processing step, the contents of agitator 160′ are agitated and then transferred to settling tank 165 as indicated by arrow D, the contents of second collection zone 155″ are transferred to agitator 160′ as indicated by arrow E, and one half of the infused media from supplemental collection zone 170′ is transferred to cultivation zone 150′. Stage (iv) indicates that agitator 160′ contains the algae culture and media that was transferred from second collection zone 155″, that settling tank 165′ contains the shredded algae culture and infused media that was transferred from agitator 160′, and that cultivation zone 150′ is now full again with algae culture and media. In a fourth processing step, the contents of agitator 160′ are agitated and then transferred to settling tank 165′ as indicated by arrow G, the contents of settling tank 165′ are flocculated and the media is transferred to first supplemental collection zone 170′ as indicated by arrow H, and one half of the infused media from second supplemental collection zone 170″ is transferred to second cultivation zone 150″ as indicated by arrow I. Stage (v) indicates that first supplemental collection zone 170′ is full of infused media, that second cultivation zone 150″ is full of algae culture and media, that second supplemental collection zone 170″ is one half full of infused media, and that settling tank 165′ contains the shredded algae culture and infused media that was transferred from agitator 160′. In a fifth processing step, the contents of settling tank 165′ are flocculated and the infused media is transferred from settling tank 165′ to second supplemental collection zone 170″ as indicated by arrow J. The entire process begins again as indicated by arrow A′, where one half of the algae culture and growth media contained in first cultivation zone 150′ is transferred to first collection zone 155′. The resulting stage (vi) is therefore similar to stage (ii). The present invention contemplates any of a variety of process configurations. For example, in some embodiments, a culture system or plant may have several photobioreactors. Similarly, a culture system having multiple photobioreactors may share common elements such as a common agitator, a common aggregator, a common heat sink, and the like. It is appreciated that the timing or sequence of various processing steps may be controlled or adjusted based on various factors. For example, during the winter there may be less light available to support algal growth, and therefore oil harvesting may occur at a reduced pace. The culture system may carry out a reduced number of production cycles per day, month, or other time period.

FIG. 1F provides a schematic representation of an exemplary algae culture processing method according to embodiments of the present invention. With reference to stage (i), a first photobioreactor includes a first cultivation zone 150′, a first collection zone 155′, a first supplemental collection zone 170′, and a first heat sink 180′. In some embodiments, a culture system or culture plant may include one or more photobioreactors. Thus, the culture system depicted in stage (i) includes a second photobioreactor that includes a second cultivation zone 150″, a second collection zone 155″, a second supplemental collection zone 170″, and a second heat sink 180″. The culture system also includes an agitator 160′ and a settling tank 165′. Stage (i) indicates that cultivations zones 150′ and 150″ are each full of algae culture and media, and supplemental collection zones 170′ and 170″ are each full of infused culture media. In a first processing step, as indicated by arrows A, one half of the algae culture and media contained in first cultivation zone 150′ is transferred to first collection zone 155′, and one half of the algae culture and media contained in second cultivation zone 150″ is transferred to second collection zone 155″. Stage (ii) indicates that first cultivation zone 150′, first collection zone 155′, second cultivation zone 150″, and second collection zone 155″ are each one half full of algae culture and media. In a second processing step, as indicated by arrows B, one half of the infused culture media contained in first supplemental collection zone 170′ is transferred to first cultivation zone 150′, and one half of the infused culture media contained in first supplemental collection zone 170″ is transferred to second cultivation zone 150″. By adding infused culture media to the first and second cultivation zones (i.e. stage (ii)) immediately or soon after one half of their contents have been removed (i.e. stage (i)) it is possible to maximize amount of time in the algal growth cycle. Consequently, it is noted that the cultivation tanks are filled in stages (i) and (iii)-(vi). Stage (iii) indicates that first and second cultivation zones 150′ and 150″ are each filled with original algae culture and media in addition to the newly added infused media. First and second collection zones 155′ and 155″ are half filled with algae culture and media, and first and second supplemental collection zones 170′ and 170″ are half filled with infused culture media. As indicated by arrow C, the algae culture and media from first collection zone 155′ can be transferred to agitator 160′. Stage (iv) indicates that agitator contains the algae culture and media from first collection zone 155′. As shown by arrow D, after an agitation processing step, the contents of agitator 160′ can be transferred to aggregator 165′. Further, as shown by arrow E, the algae culture and media from second collection zone 155″ can be transferred to agitator 160′. Stage (v) indicates that agitator 160′ contains the algae culture and media from second collection zone 155″, and aggregator 165′ contains the processed algae culture and media (e.g. shredded algae culture and infused media) from agitator 160′. In a further processing step, the contents of aggregator 165′ are flocculated and the infused media is transferred from aggregator 165′ to first supplemental collection zone 170′ as indicated by arrow F. After an agitation processing step, the contents of agitator 160′ can be transferred to aggregator 165′ as indicated by arrow G. Stage (vi) indicates that first supplemental collection zone 170′ is filled with infused media, and aggregator 165′ contains processed algae culture and media from agitator 160′. After an aggregation step, infused media can be transferred from aggregator 165′ to second supplemental collection zone 170″ as indicated by arrow H. As noted above, the process illustrated in FIG. 1F provides an increased or maximized growing time cycle, as the cultivation zones are filled for a substantial portion of the time. An individual growth cycle can be any desired amount of time, for example 12 hours, 24 hours, and the like. This embodiment allows various procedure steps (e.g. agitation, aggregation) to be carried out while maximum growth occurs in the cultivation zones. In some embodiments, the contents of one or more collection zones can be transferred to the agitator and subsequently processed downstream.

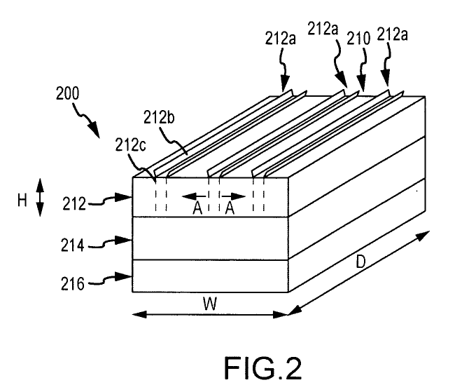

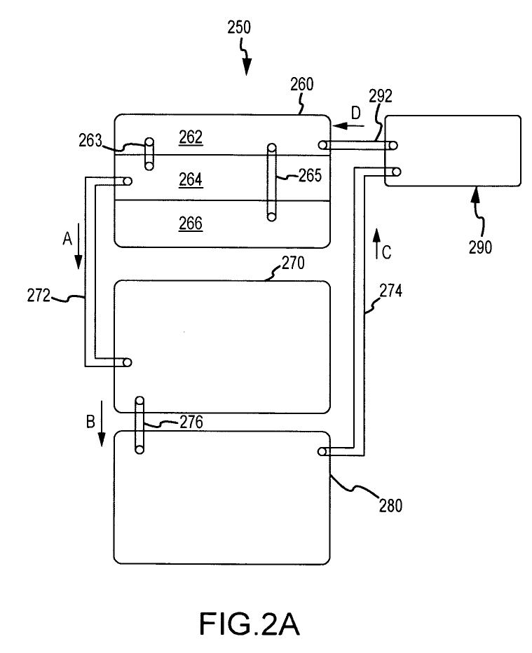

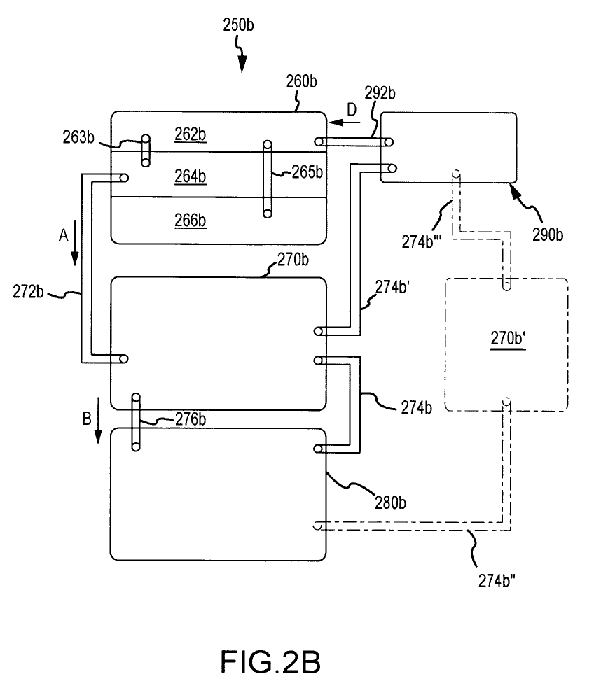

FIG. 2 illustrates a photobioreactor 210 of a culture system 200 according to embodiments of the present invention. Photobioreactor 210 includes a cultivation zone 212, a collection zone 214, and a heat sink 216. Cultivation zone 212 can be in fluid communication with collection zone 214. Heat sink 216 can be configured to receive or conduct heat from cultivation zone 212. In use, an algae culture can be grown or maintained in cultivation zone 212. Typically, cultivation zone 212 provides energy and nutrient requirements sufficient to support, facilitate, or optimize algae growth. The cultivation zone as shown in FIG. 2 can have a height H of 3.5′, a width W of 40′, and a depth D of 11′. An exemplary algae farm may include 100 such photobioreactors in a 10×10 array, such that they occupy about 1 square acre. The cultivation zones, collection zones, and heat sinks may be enclosed with injection molded plastic panels. In some cases, for example, a common side panel may be shared by two adjacent photobioreactors. Cultivation zone 212 may include one or more light transmission assemblies 212a. A light transmission assembly 212a may include a light collecting and concentrating means 212b and a light dispersing or distributing means or illuminator 212c. In some embodiments, light dispersing means 212c may be spaced at regular intervals within the cultivation zone. For example, adjacent light dispersing means or illuminators 212c may be separated by a spacing of 16″. Light dispersing means or illuminators 212c can radiate light as indicated by arrows A, and thus can illuminate or provide light energy to an algae culture contained in cultivation zone 212.

FIG. 2A shows a culture system 250 according to embodiments of the present invention. Here, culture system 250 includes a photobioreactor 260, an agitator 270, an aggregator 280, and a supplemental collection zone or tank 290, which may or may not be coupled with or stacked against or between tanks or zones of the photobioreactor. Supplemental collection zone 290 can be used for a variety of purposes. For example, zone 290 may hold liquid media or water following a harvesting step, for recycling materials to a cultivation zone, for receiving materials from an agitator or an aggregator, and the like. In an exemplary method, algae culture and media are transferred from cultivation zone 262 to collection zone 264 through conduit 263, and then are transferred to agitator 270 through conduit 272, as indicated by arrow A. Following an agitation procedure which separates or releases oil from the algae and optionally infuses media with carbon dioxide or other gases or nutrients, the shredded algae and infused media contents are transferred from agitator 270 to aggregator 280 via conduit 276, as indicated by arrow B. The shredded algae culture and media can then be flocculated in aggregator or flocculation tank 280 such that oil is separated from the media, and algae pulp is aggregated. Media can be transferred from aggregator 280 to supplemental collection zone 290 via conduit 274 as indicated by arrow C. Media can remain in supplemental collection zone 290 as desired, and then can be transferred to cultivation zone 262 via conduit 292 as indicated by arrow D. A heat sink 266 can transfer heat to or draw heat from cultivation zone 262 via conduit 265.

In some cases, algae is kept intact as a whole cell, or is otherwise not disrupted or shredded to allow separation of lipid from pulp, prior to placement in a gasification assembly. Thus, the process of agitating the algae, for example in a rotational agitation device, is optional. In such cases, both lipid and pulp remain associated and can be introduced together into the gasification assembly. Such techniques may be particularly desirable in electricity production methods. With reference to FIG. 2A, this approach involves transferring nondisrupted or nonagitated algae to aggregator 280, for example directly from photobioreactor 260, without having processed the algae in agitator 270. In this way, aggregator 280 can operate to aggregate or flocculate whole cell or nondisrupted algae, whereby the flocculate contains both lipid and pulp.

As depicted in FIG. 2B, in some cases shredded algae culture and media can be transferred from agitator 270b to aggregator 280b, where the shredded algae culture and media can be processed to separate oil and pulp from the media. Further, media can be returned to agitator 270b, or optionally transferred to a second agitator 270b′, where the media can be infused with carbon dioxide or other gases or nutrients. The infused media can then be transferred from agitator 270b or 270b′ to supplemental collection zone 290b or cultivation zone 262b via any suitable conduit configuration. For example, media can be transferred from aggregator 280b to agitator 270b via a conduit 274b, from agitator 270b to supplemental collection zone 290b via a conduit 274b′, from aggregator 280b to agitator 270b′ via a conduit 274b″, or from agitator 270b′ to supplemental collection zone 290b via a conduit 274b′″.

Culture system 250b includes a photobioreactor 260b, an agitator 270b, an aggregator 280b, and a supplemental collection zone or tank 290b, which may or may not be coupled with or stacked against or between tanks or zones of the photobioreactor. Supplemental collection zone 290b can be used for a variety of purposes. For example, zone 290b may hold liquid media or water following a harvesting step, for recycling materials to a cultivation zone, for receiving materials from an agitator or an aggregator, and the like. In an exemplary method, algae culture and media are transferred from cultivation zone 262b to collection zone 264b through conduit 163b, and then are transferred to agitator 270b through conduit 272b, as indicated by arrow A. Following an agitation procedure which separates or releases oil from the algae and optionally infuses media with carbon dioxide or other gases or nutrients, the shredded algae and infused media contents are transferred from agitator 270b to aggregator 280b via conduit 276b, as indicated by arrow B. The shredded algae culture and media can then be flocculated in aggregator or flocculation tank 280b such that oil is separated from the media, and algae pulp is aggregated. Media can be transferred from aggregator 280b to supplemental collection zone 290b. Media can remain in supplemental collection zone 290b as desired, and then can be transferred to cultivation zone 262b via conduit 292b as indicated by arrow D. A heat sink 266b can transfer heat to or draw heat from cultivation zone 262b via conduit 265b.

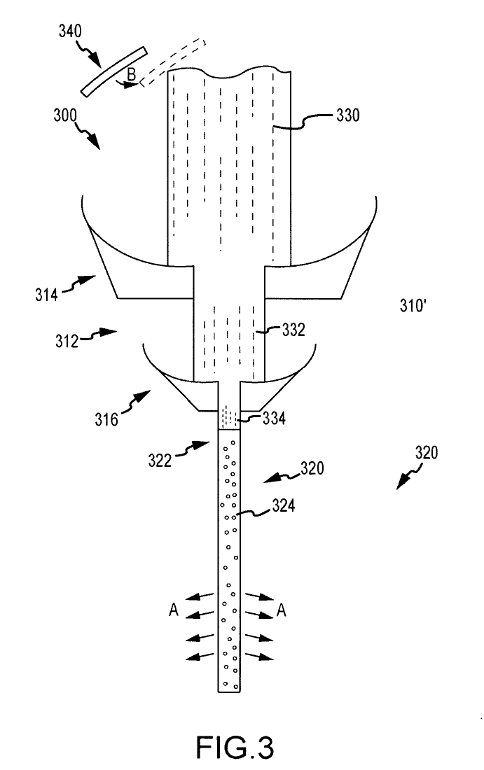

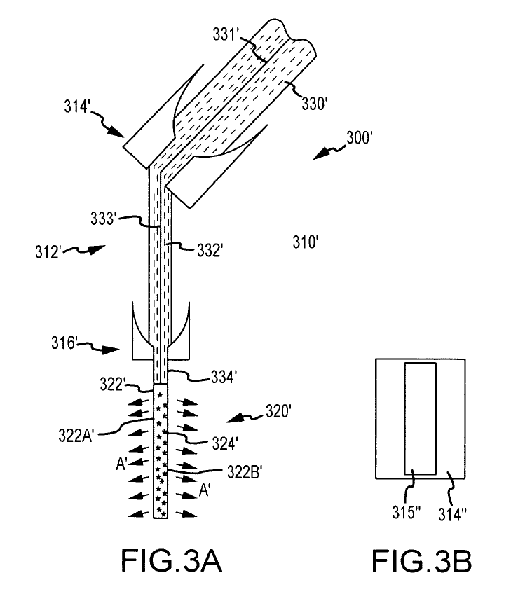

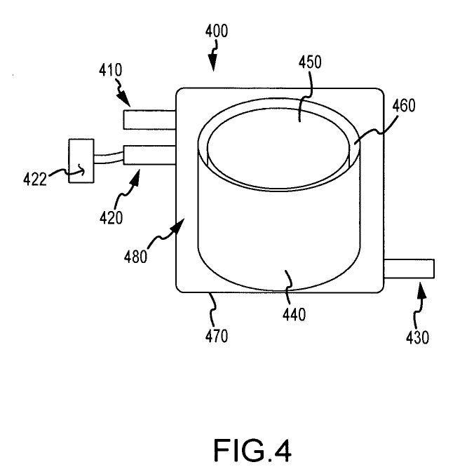

FIG. 3 depicts a light transmission assembly 300 of a culture system according to embodiments of the present invention. Light transmission assembly 300 may include a light collecting and concentrating means 310 and a light dispersing or distributing means or illuminator 320. The light collecting and concentrating means 310 can have one or more light concentration surfaces that aid in directing light into or toward the light diffusing device or illuminator. Sunlight or other ambient light can be collected, concentrated, and transmitted into the dispersing device or illuminator 320. In some embodiments, a light concentration surface or collecting and concentrating means 310 can include a linear Fresnel lens, a compound parabolic concentrator, a tandem compound parabolic concentrator, and the like. The light transmission assembly shown in FIG. 3 includes a tandem compound parabolic concentrator 312 that includes a first compound parabolic concentrator 314 and a second compound parabolic concentrator 316. A parabolic concentrator can include curved or parabolic shaped reflective or mirrored surfaces that face toward each other or otherwise operate to reflect or direct light toward a common point or area. Typically, first compound parabolic concentrator is disposed closer to the sun or other light source. First compound parabolic concentrator 314 may be adapted to collect a light beam having a diameter of about 16 inches. First compound parabolic concentrator 314 may be separated from second compound parabolic concentrator 316 by about 6 inches. In some embodiments, such a concentrator may resemble a trough. Scaffolding (not shown) may hold or secure components of the light transmission assembly in place.

In use, light transmission assembly can focus or concentrate a stream of light 330 into a focused or concentrated stream of light 332, and then into a further focused or concentrated stream of light 334, which is then transmitted to a first portion 322 of light dispersing means or illuminator 320. In some embodiments, concentrated stream of light 334 has a width of about 8 to 10 mm, and correspondingly, diffusing member or illuminator 320 has a width of about 8 to 10 mm. The stream of light can be diffused or distributed in light dispersing means or illuminator 320. In some cases, the light dispersing means or diffusing member 320 includes a diffusing plate having diffuser or reflector particles 324 embedded therein. Optionally, light distributing means or illuminator includes a reflector disposed between a first surface 322a of the illuminator, and a second surface 322b of the illuminator that opposes the first surface. After passing through diffusing member or illuminator 320, the stream of light is radiated from the diffusing member or illuminator, as indicated by arrows A. Diffusing member or illuminator 320 may include a Plexiglas® panel or an Acrylite® Endlighten acrylic sheet (e.g available from CYRO Industries, Rockaway N.J.). In some embodiments, diffusing member or illuminator 320 includes an edge-lit acrylic polymer sheet. Relatedly, diffusing member or illuminator 320 can include a Plexiglas® acrylic sheet using edge-lit technology (ELiT). Such products can be made by extrusion or casting. In some embodiments, diffusing member or illuminator 320 can provide uniform illumination throughout the member, and can also provide about 92% light transmission. In some embodiments, diffusing member or illuminator 320 can provide nonuniform illumination throughout the member. Often, diffusing member or illuminator 320 includes an additive that scatters light that is introduced at its edges, so that the light diffuses evenly or otherwise as desired through the surfaces of the diffusing member. Thus, when light is focused on the edge of the sheet, the light can be transmitted and evenly diffused to both faces of the sheet. Advantageously, diffusing member or dispersing device 320 allows light energy to be distributed to lower or subsurface levels of a cultivation zone, where algae may otherwise not receive sufficient light energy to sustain growth or maintenance.

In some embodiments, light transmission assembly 300 may include one or more covers or films 340 that can be moved as shown by arrow B so as to block or filter at least a portion of the stream of light 330. Such covers or films can be used to modulate the amount of light entering the collecting and concentrating means 310. Such features may be useful in maintaining optimum or desired growing conditions within the photobioreactor. For example, if an excessive amount of light enters the growth media, the algae may be prompted to form a thick mat. In some embodiments, a cover or film may be transparent. These elements may also be used to protect light transmission assembly components that may otherwise be damaged by hail, wind, and the like. Covers 340 or other light transmission assembly components may also include means for absorbing or filtering light of certain wavelengths, or for modulating the intensity of light that is transmitted through the assembly. For example, diffusing member 320 or cover 340 may include a radiative selective coating or material that blocks, reflects, or filters light of a certain wavelength, while allowing light of another wavelength to pass therethrough. This feature can be used to facilitate or inhibit the growth of algae strains that are responsive to wavelength-specific radiation. In some cases, it may be desired to prevent excessive infrared light from entering the cultivation zone, as such light may generate unwanted heat. Thus, for example, diffusing member 320 or cover 340 may include a material that reflects infrared light and at the same time transmits light that promotes algae growth.

FIG. 3A depicts a light transmission assembly 300′ of a culture system according to embodiments of the present invention. Light transmission assembly 300′ may include a light collecting and concentrating means 310′ and a light dispersing or distributing means or illuminator 320′. The light collecting and concentrating means 310′ can have one or more light concentration surfaces that aid in directing light into or toward the light diffusing device or illuminator. Sunlight or other ambient light can be collected, concentrated, and transmitted into the dispersing device 320′. In some embodiments, a light concentration surface or collecting and concentrating means 310′ can include a linear Fresnel lens, a compound parabolic concentrator, a tandem compound parabolic concentrator, and the like. Hence, a light concentration surface may have a parabolic shape. As shown in FIG. 3A, light transmission assembly 300′ can direct light along a first axis 331′ and a second axis 333′, where the first axis is not collinear with the second axis. For example, in some situations it may be desirable to collect light from a certain direction as indicated by axis 331′ and then redirect the light in a second direction as indicated by axis 333′. For example, by providing a first compound parabolic concentrator 314′ having such a tilt, it may be possible to eliminate the need for a tracking mechanism. However it is appreciated that in some embodiments, the light transmission assembly includes a tracking mechanism that allows the concentrator to align with the light source, which is often the sun. The light transmission assembly may also include motor controls that adjust the angle of tilt in one or more elements of the concentrator 312′, which can modulate the amount of light being concentrated.

The light transmission assembly shown in FIG. 3A includes a tandem compound parabolic concentrator 312′ that includes a first compound parabolic concentrator 314′ and a second compound parabolic concentrator 316′. In use, light transmission assembly can focus or concentrate a stream of light 330′ into a focused or concentrated stream of light 332′, and then into a further focused or concentrated stream of light 334′, which is then transmitted to a first portion 322′ of light dispersing means or illuminator 320′. In some cases, the light dispersing means or diffusing member 320′ includes a diffusing plate having diffuser or reflector particles 324′ embedded therein. Optionally, the light distributing means or illuminator includes a reflector disposed between a first surface 322a′ of the illuminator, and a second surface 322b′ of the illuminator that opposes the first surface. After passing through diffusing member or illuminator 320′, the stream of light is radiated from the diffusing or distributing member, as indicated by arrows A′. FIG. 3B illustrates a top view of a compound parabolic concentrator 314″ according to embodiments of the present invention. As shown here, a trough-like compound parabolic concentrator 314″ includes a long rectangular aperture 315′.

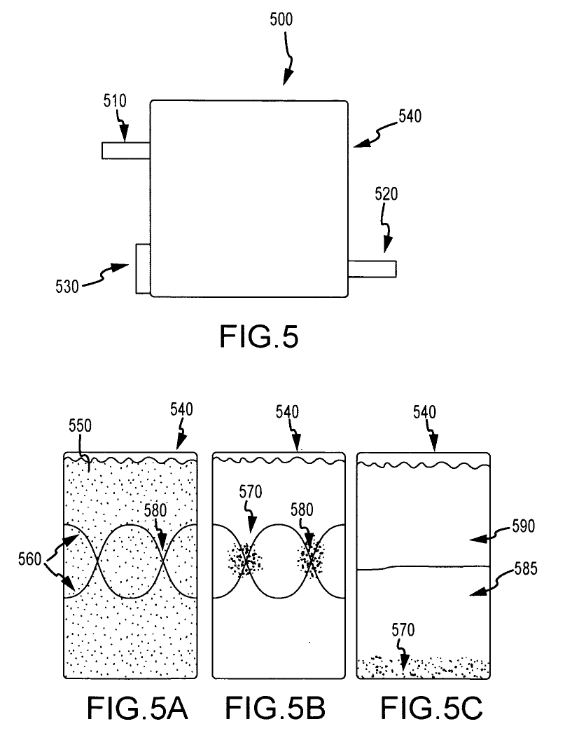

FIG. 4 illustrates an agitator 400 of a culture system according to embodiments of the invention. Agitator 400 includes a first input port 410 for receiving materials from a harvest zone of a photobioreactor, a second input port 420 for receiving materials for supplementing an algae growth media, and a first output port 430 for transmitting materials to an aggregator. Agitator 400 further includes a cavitation means 480, such as a housing 440 and a rotor 450, within an agitator body 470. As shown here, both rotor 450 and housing 440 are cylindrical in shape, and rotor 450 is disposed at least partially within housing 440 in concentric arrangement. A space 460 is present between rotor 450 and housing 440. In use, algae culture and media from a photobioreactor can be transmitted through input port 410 into agitator body 470. As relative rotational movement is generated between rotor 450 and housing 440, algae present in space 460 is lysed due to the resulting cavitation. The cell walls of the algae are broken, and algal oil or lipids are released from the algae into suspension. Thus, the cavitation, or sonic disruption, shreds the outer membrane of the algae.

In some embodiments, carbon dioxide and other gases or nutrients can be introduced from a source 422 into agitator body 470 via second input port 420. When the cavitation means 480 is activated, these gases or nutrients can be dissolved or otherwise incorporated into the media. Suitable cavitation means include cavitation wheels, hydrodynamic wheels, and the like. Any of a variety of supplemental materials may be introduced or dissolved into the media, including carbon dioxide, nitrogen (e.g. ammonium nitrate), phosphate, and the like. Carbon dioxide may be generated as a product of thermal biomass gasification in a wood gas generator, a downdraft gasifier, or the like. For example, wood can be gasified to produce wood gas, which is then burned directly in a spark ignition engine to produce electricity with a carbon dioxide exhaust. In another embodiment, wood gas can be treated with a steam process to produce liquid methanol, which can either be burned directly in a spark ignition engine or cracked to produce hydrogen and carbon dioxide. In some embodiments, carbon dioxide is purchased from a commercial supplier. It will be appreciated that systems and methods according to the present invention are well suited for carbon fixation or sequestration.

Hence, embodiments of the present invention provide for the ability to finely control or adjust the amount of nutrients, gasses, and other materials that are introduced into the media during agitation. Combined with the light control and temperature control aspects previously discussed, these culture systems are well suited for use in any of a variety of geographical climates and microclimates, where algae growing conditions may benefit from careful monitoring, adjustment, and optimization.

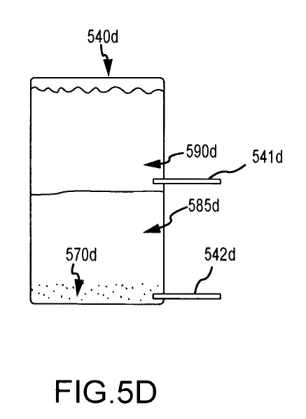

FIG. 5 shows an aggregator 500 of a culture system according to embodiments of the present invention. Aggregator 500 can be configured to facilitate the separation of a biofuel from a microalgae biomass. Aggregator 500 includes a first input port 510 for receiving material from an agitator, a first output port 520 for transmitting material to a photobioreactor, an ultrasonic generator 530, and an aggregation tank 540. In use, a lysed algae culture from an agitator is received into aggregation or flocculation tank via first input port 520. The lysed algae culture typically includes amounts of oil or lipids, water, and algae lysate or pulp. The aggregator acts to agglomerate algae pulp and to separate out components into layers or zones within aggregation tank 540. In some embodiments, aggregation tank 540 is shaped like an onion. Although such settlement or separation may occur naturally or as a result of gravitational forces alone, the application of ultrasound can expedite the settlement process, and can reduce amount of storage needed for a culture system. FIGS. 5A-5C show a time course sequence of an aggregation process. As depicted in FIG. 5A, flocculation tank 540 contains a homogenous mixture 550 of materials received from an agitator. The mixture can include oil, water, and algae pulp particulates. A standing wave 560 can be generated by a standing sonic wave generator. Upon application of standing wave 540, algae pulp particulates 570 aggregate at pressure nodes 580 in the ultrasonic field in a flocculation step, as shown in FIG. 5B. Upon sedimentation, pulp particulates 570 settle to the bottom of flocculation tank 540, and oil 590 and water 585 components separate. The algal oil 590 can then be easily removed from the tank, thus providing an effective and efficient approach for extracting an algal oil from an algae culture. According to the embodiment illustrated in FIG. 5D, a flocculation or aggregation tank 540d may have a first outlet passage 541d disposed toward a top portion of the tank, and a second outlet passage 542d disposed toward a bottom portion of the aggregation tank. In use, after algal oil 590d and pulp 570d are separated from water or media, pulp can settle toward the bottom of the tank, separate from the algal oil which rises toward the top of the tank. It is possible to remove the algal oil through the first passage disposed toward a top portion of the aggregation tank, and also remove the pulp through the second passage disposed toward a bottom portion of the aggregation tank. Some exemplary embodiments include transferring a volume that includes at least a portion of the suspension remaining in the aggregation tank to the agitator. This volume of suspension may include media, water, or the like. Such methods can include infusing the volume with carbon dioxide and nutrients via a cavitation process provided by the agitator.

Algal oil retrieved from an aggregator can be processed into biodiesel. In some embodiments, this process involves the chemical conversion of algal oil to its corresponding fatty ester via transesterification. In an exemplary transesterification process, using sodium ethanolate or sodium hydroxide as a catalyst, ethanol or methanol can be reacted with algal oil to produce biodiesel and glycerol. Biodiesel engines are often more efficient than gasoline engines. The culture system described herein provides a sustainable, recyclable closed system that avoids the problems associated with contamination, such as the introduction of algae strains from the outside environment.

Embodiments of the present invention provide techniques for replacing the fossil feedstocks of crude oil, coal, and natural gas used for transportation, electric power, and other energy purposes. For example, exemplary systems and method can provide 25,000 gallons of biodiesel per year, per acre, and 175,000 gallons of methanol per year, per acre, from the same acre in the same year. Embodiments provide sources of electric power and diesel fuel while eliminating pollution from existing sources, and reduced costs for electricity and diesel. In some cases, an energy production system includes a photobioreactor, which may be a closed tank, that contains water, nutrients, algae, and solar plates that distribute sunlight throughout the tank between the top and the bottom. Exemplary designs allow all or substantially all available sunlight to be distributed inside the photobioreactor. Photobioreactor embodiments of the present invention can prevent or minimize natural growth inhibitors to solar energy conversion, including potential problems with density and light gradients, shading, photoinhibition, non-optimized nutrients, non-optimized growth cycle stage, angle of incidence, and the like. Moreover, photobioreactor embodiments can prevent or minimize potential inhibitory factors associated with dissolved O2 saturation, CO₂ uptake efficiency, temperature, species invasion, harvesting, and the like.

Algae can be processed to provide methanol. Embodiments of the present invention can involve the production of methanol, the conversion of methanol to electricity, and the use of methanol in biodiesel refining. Such processes can be carried out while capturing and recycling CO₂ that can be used to grow the algae in a photobioreactor. The photobioreactor can produce O₂ which can be used in a hydrogen fuel cell generator. Electricity can be generated in hydrogen fuel cells using methanol. Aspects of the use of methanol in H₂ fuel cells are discussed in H. Purnama, “Catalytic Study of Copper Based Catalysts for Steam Reforming Methanol,” U. of Berlin, 2003, the contents of which are incorporated herein by reference. Aspects of the conversion of algae to biodiesel and algae growth rates are discussed in Sheehan et al., “A Look Back at the Department of Energy's Aquatic Species Program—Biodiesel from Algae” NREL/TP-580-24190, July 1998, the contents of which are incorporated herein by reference.

In some embodiments, most of the sunlight shining on a top surface of the photobioreactor can be delivered several feet into the interior of the photobioreactor. In some cases, up to 85% or more of the sunlight is available for photosynthesis. Environmental variables which contribute to algae growth can be optimized to allow the algae to use all or most of the available sunlight for photosynthesis. Exemplary environmental variables include, without limitation, factors associated with shading, photoinhibition, non-optimized nutrients, non-optimized growth cycle stages, angle of incidence, dissolved O₂ saturation, CO₂ uptake efficiency, temperature, species invasion, species selection, harvesting cycles, and respiration timing and control. Such variables can impact growth rates and yield. Because large percentages and amounts of sunlight are made available by the high yield photobioreactor embodiments of the present invention, which can be harvested daily, there is now value in optimizing such variables. Relatedly, harvesting can be performed once daily, twice daily, or as frequently as desired. In some cases, harvesting is performed continuously.

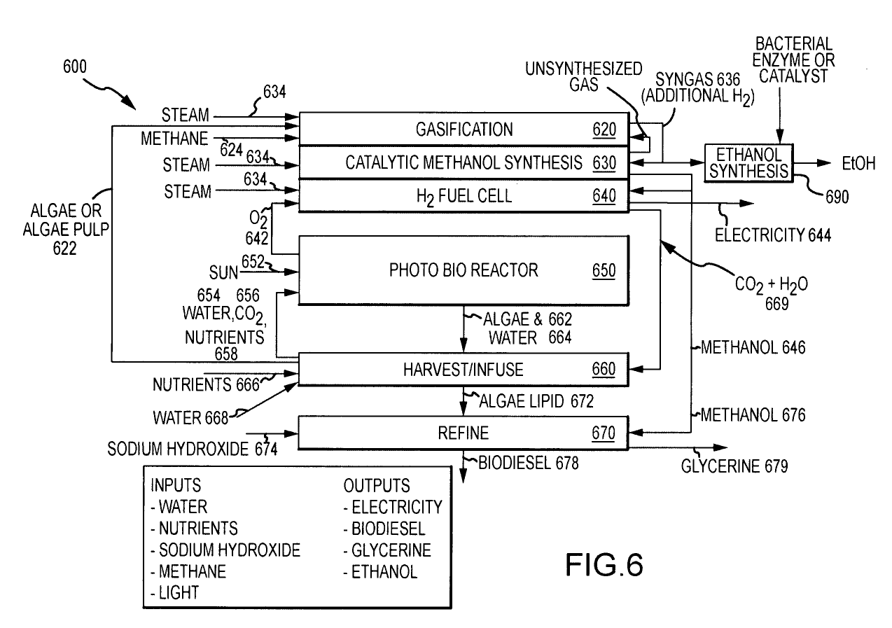

FIG. 6 illustrates an exemplary system 600 for producing electricity, biodiesel, and ethanol from an algal culture. System 600 can be used in conjunction with or incorporated into any of the culture systems, or components thereof, described herein. Similarly, any of the culture systems, or components thereof, described herein can be used in conjunction with or incorporated into system 600. As shown in this embodiment, system 600 includes a gasification assembly 620, an ethanol synthesis assembly 690, a catalytic methanol synthesis assembly 630, an H₂ fuel cell assembly 640, a photobioreactor assembly 650, a harvesting and infusing assembly 660, and a refining assembly 670.

Gasification Assembly

Gasification assembly 620 can operate to convert algae, algae pulp, or other biomass into a gas mixture, or Syngas. According to some embodiments, steam 634 can be placed or directed into gasification assembly 620 from a steam source. Algae or algae pulp 622 can be transferred from harvesting and infusing assembly 660 to gasification assembly 620. In some embodiments, the gasification encompasses a catalytic gasification. The constitution of the Syngas may vary depending on the algae strain and other gasification conditions. The gas mixture may contain a variety of gases, including hydrogen, carbon monoxide, carbon dioxide, and other hydrocarbons. It is understood that gasification of organic material can be performed catalytically or noncatalytically. Noncatalytic gasification can result in higher amounts or percentages of endogenous methane, whereas catalytic gasification can result in relatively lower amounts or percentages of endogenous methane. For example, a noncatalytic gasification can provide gas having 14% volume of endogenous methane, and a catalytic gasification can provide gas having 2% volume of endogenous methane. A relatively lower percentage of endogenous methane present in a catalytically produced Syngas can be attributed to catalytic processing or cracking of endogenous methane. According to some embodiments, the gas composition from gasified biomass after catalytic cracking of endogenous methane from biomass can include, by volume percentage, 55.7% hydrogen, 21.4% carbon monoxide, 2% methane, 20.7% carbon dioxide, 0.09% ethylene (C₂H₄), and 0.05% ethane (C₂H₆). As noted above, the composition of the resulting Syngas may vary depending on the algae strain and other gasification conditions, including temperature, pressure, catalyst composition, and the like. Cracking can be performed with any suitable catalyst. For example, a catalyst containing nickel can be used in the cracking process.

Gasification assembly 620 can also operate to crack endogenous or exogenous methane to form hydrogen. As shown in FIG. 6, methane 624 can be delivered to gasification assembly 620. For example, exogenous methane 624 can be transferred from an external methane source to gasification assembly 620. In some embodiments, the methane source can include methane from a renewable source such as an anaerobic digester. Hence, there may be no net production of green house gases. Subsequent to the injection or introduction of exogenous methane, gasification assembly 620 may include methane resulting from gasification of algae, in addition to the exogenous methane, and therefore gasification assembly 620 may operate to crack both the endogenous methane and the exogenous methane. Exogenous methane 624 can be catalytically cracked to provide additional hydrogen to the Syngas so that all carbon monoxide and carbon dioxide can be converted to methanol, or to otherwise increase the amount or percentage of carbon monoxide, carbon dioxide, or both, that is converted to methanol. Syngas 636, along with the additional hydrogen, can be transferred from gasification assembly 620 to catalytic methanol synthesis assembly 630, ethanol synthesis assembly 690, or both.

The technique of introducing additional exogenous methane to the gasification assembly provides significant advantages over traditional biomass processing approaches, because the additional methane can be cracked to produce additional hydrogen which can be used to reduce carbon dioxide in the Syngas. In this way, a gasification assembly can operate to crack methane from two separate and distinct sources. For example, the gasification assembly can crack endogenous methane that results from the gasification of algae or algae pulp. Further, the gasification assembly can crack exogenous methane which is injected from an external source. What is more, as compared with traditional gasification processes that involve the conversion of unreduced carbon dioxide to liquid acid, gasification processes with the additional external methane can eliminate the need for such acid wash steps. The additional externally injected methane, when cracked, produces additional methanol plus surplus hydrogen that can then combines with the free, unreduced carbon dioxide from the algae gasification to make additional methanol. Such techniques can greatly improve or increase methanol output from the catalytic methanol synthesis.

It is possible to determine an amount of additional methane to introduce, and to determine an amount of additional carbon dioxide that is produced, based on the following formula.

3CH₄+2H₂O+CO₂=4CH₃OH

Thus, according to embodiments of the present invention, each remaining, unreduced mole of carbon dioxide may be reacted with 3 moles of methane and 2 moles of water to produce 4 moles of methanol.

Ethanol Synthesis Assembly

Ethanol synthesis assembly 690 can operate to convert gas produced by or received from gasification assembly 620 into ethanol. Hence, in some embodiments, gas mixture 636 can be processed to obtain ethanol. For example, gas mixture 636 can be cooled and processed with a bacterial culture or enzyme to produce ethanol. Optionally, gas mixture 636 can be treated catalytically with a catalyst to obtain ethanol. Embodiments of the present invention encompass systems and methods for deciding or determining relative amounts of methanol and ethanol that are produced from algae pulp feedstock. These decisions can be made based on economic considerations such as fuel prices, feedstock costs, and the like.

Catalytic Methanol Synthesis Assembly

Catalytic methanol synthesis assembly 630 can operate to perform a reaction in which Syngas is converted to methanol. This process can involve different types of reactions, including catalytic reactions. For example, Syngas can be processed with steam and a catalyst to provide methanol. In some embodiments, the Syngas includes a mixture of carbon monoxide and carbon dioxide. The reaction can involve processing all or substantially all of the carbon monoxide of the Syngas, but only some of the carbon dioxide. As noted above, methane can be cracked in gasification assembly 620 to provide additional hydrogen to the Syngas. In some embodiments, this additional hydrogen can allow all or substantially all of the carbon dioxide in the Syngas to be reduced, thus producing additional methanol. Steam 634 can be placed or directed into catalytic methanol synthesis assembly 630 from a steam source. A gas 636, for example Syngas, can be transferred from gasification assembly 620 to catalytic methanol synthesis assembly 630. Gas 636 can include varying amounts of carbon monoxide, carbon dioxide, hydrogen, other hydrocarbons, and the like, generated by algae gasification. As noted above, gas 636 can include gases produced from the gasification of the algae pulp, and optionally additional hydrogen produced from cracked methane. According to some embodiments, carbon dioxide or hydrogen gas that is unsynthesized or not converted to methanol in catalytic methanol synthesis assembly 630 can be recycled or transferred into gasification assembly 620. Any or all gas that is not converted to methanol can be reinjected into the gasification assembly. The ratio of injected external methane to gasifier produced methane can be adjusted so that all or most of the carbon dioxide from the gasification process can be ultimately reduced to methanol and little or none is released as an emission or byproduct.

As noted above, methane can be present in the gasification assembly as a product of the algae pulp gasification. The methane cracking catalyst that is present in the gasification assembly can also be used to crack any additional external methane that is injected or introduced into the gasification assembly. This additional externally injected methane, when cracked, can produce additional methanol plus surplus hydrogen that can be combined with free, unreduced carbon dioxide from the algae pulp gasification to produce additional methanol. According to some embodiments, this technique can increase the methanol output of a gasification process and may eliminate the need for an acid wash step found in traditional gasification processes that convert unreduced CO2 to a liquid acid.

H₂ Fuel Cell Assembly

H₂ fuel cell assembly 640 can operate to perform an electrochemical energy conversion, producing electricity 644 from a fuel such as methanol 646 and an oxidant such as oxygen 642. This conversion may involve the presence of steam 634. Hence, according to some embodiments steam 634 can be placed or directed into H₂ fuel cell assembly 640 from a steam source. Methanol 646 can be transferred to H₂ fuel cell assembly 640 from catalytic methanol synthesis assembly 630. Oxygen 642 can be transferred to H₂ fuel cell assembly 630 from photobioreactor assembly 650. Steam 644 may be placed or directed into H₂ fuel cell assembly 640 from a steam source. In addition to producing electricity 644, fuel cell assembly 640 can also produce carbon dioxide and water 669, which can be transferred from fuel cell assembly 640 to harvesting and infusing assembly 660. In some cases, water is transferred along with carbon dioxide from fuel cell assembly 640 to harvesting and infusing assembly 660. In some embodiments, the electrochemical energy conversion in fuel cell assembly 640 involves a high temperature condition, but not the presence of a catalyst.

Photobioreactor Assembly

Photobioreactor assembly 650 can include features and components of photobioreactors described elsewhere herein. As seen in FIG. 6, the components that are placed or directed into photobioreactor assembly 650 include sunlight 652, water 654, carbon dioxide 656, and nutrients 658. Photobioreactor assembly 640 contains an algal culture which is nourished by these growth components. Any of a variety of algae strains may be grown in photobioreactor assembly 650. Oxygen 642 is produced during algae growth. Oxygen 642 can be transferred from photobioreactor assembly 650 to fuel cell assembly 640. Algae 662 and water 664 from photobioreactor assembly 650 can be transferred to harvesting and infusing assembly 660. In some embodiments, photobioreactor assembly 650 includes a pressurizing mechanism for creating a negative pressure or a positive pressure in the growth media. For example, the pressurizing mechanism can produce a negative pressure over the growth media so as to remove dissolved oxygen from the media. Excess dissolved oxygen in the media may inhibit photosynthesis in the algae culture, and induce the algae to convert to a respiration phase. In some embodiments, it may be desirable to synchronize the timing of the removal of oxygen, so as to prevent or minimize the removal of dissolved carbon dioxide from the media. For example, oxygen may be removed after the algae culture has consumed a significant portion of the dissolved carbon dioxide. In some processes, the algae is removed from photobioreactor assembly 650 at night or when in the respiration phase, and processed quickly, to stop or limit respiration. Sonic energy may be used for cleaning a cultivation zone of photobioreactor assembly 650.

Harvesting and Infusing Assembly

Harvesting and infusing assembly 660 can include features and components of agitators and aggregators described elsewhere herein. Other nutrients 666 and water 668 can be transferred to harvesting and infusing assembly 660. Also, carbon dioxide 669 optionally along with water from H₂ fuel cell assembly 640 can be transferred to harvesting and infusing assembly 660. Harvesting and infusing assembly 660 can operate to perform an agitation procedure which separates or releases oil or algae lipid 672 from the algae and infuses media with the carbon dioxide and water 669 and nutrients 666. Harvesting and infusing assembly 660 can operate to perform an aggregation procedure which flocculates shredded algae culture and infused media such that oil is separated from the media, and algae pulp is aggregated. As seen in FIG. 6, algae or algae pulp 622 can be transferred from harvesting and infusing assembly 660 to gasification assembly 620, and infused media, which may include water 654, carbon dioxide 656, and nutrients 658, can be transferred from harvesting and infusing assembly 660 to photobioreactor assembly 650. Similarly, algae lipid 672 can be transferred from harvesting and infusing assembly 660 to refining assembly 670.

Refining Assembly

Refining assembly 670 can operate to perform a transesterification reaction with algae lipid 672. Sodium hydroxide 674 can be transferred to refining assembly 674 from a sodium hydroxide source. Methanol 676 can be transferred from catalytic methanol synthesis assembly 630 to refining assembly 670. Algae lipid 672 can be transferred from harvesting and infusing assembly 660 to refining assembly 670. Transesterification involves converting algae lipid 672 and methanol 676 into biodiesel 678 and glycerin 679.

Embodiments of the invention have now been described in detail. However, it will be appreciated that the invention may be carried out in ways other than those illustrated in the aforesaid discussion, and that certain changes and modifications may be practiced within the scope of the appended claims. Accordingly, the scope of this invention is not intended to be limited by those specific examples, but rather is to be accorded the scope represented in the following claims.

What is claimed is:

1. A method of producing methanol from an algae pulp, comprising:
processing the algae pulp in a gasification assembly to produce a Syngas comprising an amount of carbon dioxide and a first amount of methane;
introducing a second amount of methane into the gasification assembly to provide a sum amount of methane in the gasification assembly;
cracking at least a portion of the sum amount of methane in the gasification assembly to provide an amount of hydrogen; and
reacting at least a portion of the amount of carbon dioxide with at least a portion of the amount of hydrogen in a catalytic methanol synthesis assembly to produce the methanol.

2. The method according to claim 1, comprising reducing substantially all of the amount of carbon dioxide to methanol.

3. The method according to claim 1, further comprising transferring an amount of unreacted gas from the catalytic methanol synthesis assembly to the gasification assembly.

4. The method according to claim 3, wherein the unreacted gas comprises unreacted carbon dioxide or unreacted hydrogen.

5. The method according to claim 4, wherein the unreacted gas comprises unreacted carbon dioxide.

6. The method according to claim 4, wherein the unreacted gas comprises unreacted hydrogen.

7. The method according to claim 3, comprising introducing a third amount of methane into the gasification assembly based on the amount of unreacted gas that is transferred from the catalytic methanol synthesis assembly to the gasification assembly.

8. The method according to claim 7, wherein the unreacted gas comprises unreacted carbon dioxide or unreacted hydrogen.

9. The method according to claim 8, wherein the unreacted gas comprises unreacted carbon dioxide.

10. The method according to claim 8, wherein the unreacted gas comprises unreacted hydrogen.

11. A method of producing electricity from an algae grown in a photobioreactor, comprising:
introducing oxygen produced by the algae into a hydrogen fuel cell assembly;
introducing an algae pulp obtained from the algae into a gasification assembly;
processing the algae pulp in the gasification assembly to produce a Syngas comprising carbon dioxide and methane;
introducing the carbon dioxide into a catalytic methanol synthesis assembly;
introducing hydrogen produced from the methane into the catalytic methanol synthesis assembly;
processing the carbon dioxide and the hydrogen in the catalytic methanol synthesis assembly to produce methanol;
introducing the methanol into the hydrogen fuel cell assembly; and
processing the oxygen and the methanol in the fuel cell assembly to produce electricity.

12. The method according to claim 11, wherein the methane is processed in the gasification assembly to produce the hydrogen.

13. The method according to claim 11, further comprising introducing water produced in the hydrogen fuel cell assembly into a harvesting and infusing assembly.

14. The method according to claim 11, further comprising introducing an algae lipid from the algae into a refining assembly and producing biodiesel from the algae lipid.

15. The method according to claim 11, further comprising producing ethanol from at least a portion of the Syngas.

16. The method according to claim 11, further comprising supporting cultivation of the algae with carbon dioxide obtained from the hydrogen fuel cell assembly.

17. A method of cultivating an algae, comprising:
introducing oxygen produced by the algae into a hydrogen fuel cell assembly;
introducing methanol produced by the gasification of an algae pulp of the algae into the hydrogen fuel assembly;
processing the oxygen and the methanol in the hydrogen fuel cell assembly to produce carbon dioxide and water; and
cultivating the algae with the carbon dioxide and the water.

18. The method according to claim 17, further comprising processing the oxygen and the methanol in the fuel cell assembly to produce electricity.

19. The method according to claim 17, further comprising producing biodiesel from an algae lipid obtained from the algae.

20. The method according to claim 17, further comprising obtaining a Syngas from the gasification of the algae pulp and processing the Syngas to produce ethanol.
